(19) United States
(12) Patent Application Publication
(10) Pub. No.: US 2018/0364046 A1
(43) Pub. Date: Dec. 20, 2018

(54) APPARATUS AND METHOD FOR DETERMINING A VEHICLE POSITION IN A FIXED-TRAFFIC-NODE COORDINATE SYSTEM

(71) Applicant: LAIRD BOCHUM GMBH, BOCHUM (DE)

(72) Inventor: AHMAD EL ASSAAD, Wolfsburg (DE)

(21) Appl. No.: 15/736,893

(22) PCT Filed: Jun. 14, 2016
(86) PCT No.: PCT/EP2016/063573

§ 371 Date: Dec. 15, 2017

(30) Foreign Application Priority Data
Jun. 15, 2015 (DE) 10 2015 210 958.5

(51) Int. Cl. G01C 21/16; G05D 1/02; G08G 1/056; G08G 1/01

(52) U.S. Cl. CPC G01C 21/16; G05D 1/0214; G05D 1/0088; G08G 1/056; G08G 1/0116; G05D 1/0289

(57) ABSTRACT

A method and an apparatus for determining a vehicle position in a fixed-traffic-node coordinate system. The apparatus includes at least one receiver for receiving a signal from a traffic-node transmission device, at least one device for determining an item of direction-of-travel information in a global reference coordinate system and at least one evaluation device. A spatial relationship between the global reference coordinate system and the fixed-traffic-node coordinate system is known in advance. The evaluation device can be used to take at least one signal property of a received signal as a basis for determining a position of the traffic-node transmission device in a vehicle coordinate system. The evaluation device can be used to determine the vehicle position in the fixed-traffic-node coordinate system on the basis of the direction-of-travel information and the position of the traffic-node transmission device in the vehicle coordinate system.

The invention relates to an apparatus and a method for determining a vehicle position in a traffic-node-fixed coordinate system.

Self-driving or so-called autonomous vehicles are the subject matter of intensive development activities. A substantial part of the development relates to the control of a traffic flow which comprises autonomous vehicles. This control is particularly relevant in the field of traffic nodes, for example, intersections.

To enable a collision-free traffic flow through the traffic nodes, it is advantageous to know the positions of all vehicles in the region of the traffic node in a traffic-node-fixed coordinate system. A traffic flow can then be controlled on the basis of these positions. To control the traffic flow, for example, control signals can be transmitted from a higher-order control unit to each autonomous vehicle. These control signals can comprise, for example, velocity control signals and direction control signals.

The technical problem results of providing a method and an apparatus for determining a vehicle position in a traffic-node-fixed coordinate system, which enable a precise implementation, which can be carried out in a chronologically rapid manner and also which saves costs and components, of such a position determination.

The solution to the technical problem results due to the subjects having the features of claims 1 and 9. Further advantageous embodiments of the invention result from the dependent claims.

It is a fundamental concept of the invention to use items of travel direction information determined by the vehicle and a position, which is also determined at the vehicle, of a traffic-node-side transmitter unit in the vehicle coordinate system, in order to determine the position of the vehicle in the traffic-node-fixed coordinate system.

An apparatus is proposed for determining a vehicle position in a traffic-node-fixed coordinate system. The apparatus can be a vehicle-side apparatus. This can mean that all elements of the apparatus are arranged in or on the vehicle.

The traffic-node-fixed coordinate system refers to a coordinate system associated with the traffic node. Parts or sections of the traffic node, for example, driving lanes of entrances and/or exits, do not change the spatial position thereof in the traffic-node-fixed coordinate system. The traffic node can comprise one or more entrances and one or more exits. Each entrance and exit can comprise at least one driving lane. In particular, the traffic node can be an intersection. The term intersection obviously also comprises a so-called T-intersection or Y-intersection in this case.

An origin of the traffic-node-fixed coordinate system can correspond, for example, to a geometrical center point of the traffic node. However, this is not required. The traffic-node-fixed coordinate system can comprise two or three spatial directions. The traffic-node-fixed coordinate system can thus comprise, for example, a traffic-node-fixed longitudinal direction (x direction) and a traffic-node-fixed transverse direction (y direction). These can be oriented orthogonally to one another and span a plane which is oriented orthogonally to a traffic-node-fixed vertical direction (z direction). The traffic-node-fixed vertical direction can be oriented in parallel to a force of gravity, wherein the vertical direction is oriented from bottom to top if it is oriented opposite to the direction of the force of gravity. The traffic-node-fixed coordinate system can also comprise the traffic-node-fixed vertical direction. However, this is not required. The traffic-node-fixed coordinate system can therefore be a two-dimensional or three-dimensional coordinate system.

The apparatus comprises at least one receiver unit for receiving a signal of a traffic-node-side transmitter unit. The position of the receiver unit in a vehicle coordinate system can be previously known. The received signal can be a high-frequency signal in particular.

The traffic-node-side transmitter unit refers in this case to a unit for transmitting signals, wherein this traffic-node-side transmitter unit is arranged fixed in place in relation to the traffic-node-fixed coordinate system. The position of the traffic-node-side transmitter unit in the traffic-node-fixed coordinate system can be previously known in this case. For example, the position of the traffic-node-side transmitter unit in the traffic-node-fixed coordinate system can be part of a traffic-node-specific item of information, which is stored in a storage unit of the vehicle or retrievable by an analysis unit of the vehicle. The traffic-node-specific item of information can thus also be stored in a vehicle-external storage unit.

It is conceivable, for example, that a position of the traffic node in a reference coordinate system is previously known. This position can also be, for example, part of the traffic-node-specific item of information. In this case, for example, a position of the vehicle can be determined in the reference coordinate system, for example, by means of a unit for position detection. This unit for position detection can be, for example, a GNSS unit. The reference coordinate system can therefore be a GNSS coordinate system. By comparing the vehicle position in the reference coordinate system and the position of traffic nodes in the reference coordinate system, the corresponding traffic node can then be selected and the traffic-node-specific items of information can be retrieved. For example, the traffic node toward which the vehicle travels and/or which has a minimum distance from the vehicle can be selected as the traffic node.

Furthermore, it is conceivable that the traffic-node-side transmitter unit is arranged at a predetermined height above a roadway surface of the traffic node, i.e., having a previously known vertical position.

The traffic-node-side transmitter unit can emit a signal. This signal can be emitted periodically, for example. Alternatively, the signal can be a response signal, wherein the response signal is emitted when a corresponding request signal has been received. The request signal can be emitted, for example, by a vehicle-side transmitter unit. It is possible that the traffic-node-fixed transmitter unit is a transceiver unit, which can receive the request signal. It is also possible that the vehicle-side receiver unit is a transceiver unit, which can emit the request signal.

Furthermore, the apparatus comprises a unit for determining an item of travel direction information in a global reference coordinate system. A spatial relationship between the global reference coordinate system and the traffic-node-fixed coordinate system is previously known. In particular, the orientation of the spatial directions or at least one spatial direction of the traffic-node-fixed coordinate system in the global reference coordinate system can be known. A location of the origin of the traffic-node-fixed coordinate system in the global reference coordinate system can also be known. However, this is not required. The global reference coordinate system can also comprise, for example, two or three spatial directions, in particular a reference-coordinate-system-fixed longitudinal direction, a reference-coordinate-system-fixed transverse direction, and optionally a reference-coordinate-system-fixed vertical direction.

The spatial relationship, in particular the orientation of the spatial directions of the traffic-node-fixed coordinate system in the global reference coordinate system, can also be part of the retrievable traffic-node-specific item of information.

One of the spatial directions, for example, the transverse direction, of the global reference coordinate system is preferably oriented toward the magnetic north pole. The transverse direction can therefore correspond to the direction “magnetic north”. In this case, a further spatial direction of the global reference coordinate system, for example, the reference-coordinate-system-fixed longitudinal direction, can be oriented orthogonally to this spatial direction and orthogonally to a direction of gravity.

At least one spatial direction of the traffic-node-fixed coordinate system is preferably parallel to a spatial direction of the global reference coordinate system. For example, each spatial direction of the traffic-node-fixed coordinate system can be parallel to one of the spatial directions of the reference coordinate system. For example, the transverse direction of the traffic-node-fixed coordinate system can be oriented parallel to the transverse direction of the global reference coordinate system. In this case, the transverse direction of the traffic-node-fixed coordinate system is also oriented toward the magnetic north pole.

Furthermore, the apparatus comprises at least one analysis unit. The analysis unit can be, for example, part of a vehicle-side control unit. Furthermore, for example, the analysis unit can be provided by a microcontroller.

By means of the analysis unit, a position of the traffic-node-side transmitter unit in a vehicle coordinate system is determinable as a function of at least one signal property of a received signal. The vehicle coordinate system refers to a coordinate system which is fixed in place in relation to the vehicle. This vehicle coordinate system can also comprise two or three spatial directions, in particular a vehicle longitudinal direction, a vehicle transverse direction, and optionally a vehicle vertical direction. The vehicle longitudinal direction can be oriented parallel to a roll axis of the vehicle, for example. The vehicle transverse axis can be oriented parallel to a vehicle pitch axis. The vehicle vertical axis can be oriented parallel to a vehicle yaw axis.

The at least one signal property can be, for example, a signal level and/or a signal intensity of the received signal. The spatial distance between the receiver unit and the traffic-node-side transmitter unit and therefore a spatial distance between the origin of the vehicle coordinate system and the origin of the traffic-node-fixed coordinate system can be determined via a previously known relationship between the signal property and a distance. The distance can be, for example, proportional to a ratio between transmitted power and received power. In this case, the transmitted power can be previously known.

Furthermore, it can be possible to determine a direction of the signal received by the vehicle-side receiver unit.

The at least one signal property is preferably a run time. The detection of the distance between the vehicle and the traffic-node-side transmitter unit can therefore be performed as a function of the run time of the signal between the traffic-node-side transmitter unit and the vehicle-side receiver unit. For this purpose, the vehicle-side transmitter unit can code a request signal with an item of information about the transmission point in time of the request signal. In the traffic-node-side receiver unit, a response signal is transmitted back with minimal time delay to the vehicle. The duration of the time delay can be coded by a signal property and therefore determined at the vehicle or can be previously known at the vehicle, for example, stored in a storage unit. The transmission point in time of the response signal then results as the total of the transmission point in time of the request signal and the duration of the time delay and the run time of the request signal. When the response signal is received in the vehicle-side receiver unit, a reception point in time can furthermore be determined at the vehicle, wherein the run time of the response signal can be determined as half of the difference between reception point in time and the total of transmission point in time of the request signal and time delay during the transmission of the response signal. The run time of the request signal also corresponds to half of this difference.

Using this method, the determination of the run time of the response signal can be carried out without time synchronization between the traffic-node-side transmitter unit and the vehicle-side receiver unit. It is also advantageous here that the response signal can be generated and transmitted as an analog and high-frequency signal in the traffic-node-side transmitter unit. A minimal time delay can thus be achieved during the generation and during the transmission of the response signal.

In summary, it is possible to assign a position in the vehicle coordinate system to the traffic-node-side transmitter unit and therefore also to the origin of the traffic-node-fixed coordinate system.

Furthermore, the vehicle position in the traffic-node-fixed coordinate system is determinable as a function of the item of travel direction information and the position of the traffic-node-side transmitter unit in the vehicle coordinate system by means of the analysis unit. Since the spatial relationship between the global reference coordinate system and the traffic-node-fixed coordinate system is previously known, via the item of travel direction information determined in the global reference coordinate system, the travel direction of the vehicle in the traffic-node-fixed coordinate system can be determined, for example, in the form of a direction vector.

For example, the vehicle position in the traffic-node-fixed coordinate system can be determined such that the item of travel direction information, for example, a travel direction vector, in the traffic-node-fixed coordinate system corresponds to the item of travel direction information in the global reference coordinate system, and also the spatial distance between the origin of the traffic-node-side coordinate system and the origin of the vehicle coordinate system in the traffic-node-fixed coordinate system corresponds to the distance in the vehicle coordinate system.

In other words, it can be determined from which direction in the traffic-node-fixed coordinate system the vehicle approaches the traffic node or in which direction in the traffic-node-fixed coordinate system the vehicle moves away from the traffic node. This enables the assignment of the vehicle to a part or section of the traffic node, for example, to a driving lane. As a function of this assignment and the distance, the vehicle position in the traffic-node-fixed coordinate system can then be determined. This means that individual steps of the method are also used for determining a driving-in direction into the traffic node region. A method for determining a driving-in direction into the traffic node region is therefore also described.

In particular, a transformation rule, in particular a transformation matrix, can be determined as a function of the item of travel direction information, wherein by means of the transformation rule, the position of the traffic-node-side transmitter unit in the vehicle coordinate system can be converted into the vehicle position in the traffic-node-fixed coordinate system. This can be carried out, for example, via a multiplication of the transformation matrix with a position vector, wherein the position vector codes the position of the traffic-node-side transmitter unit in the vehicle coordinate system.

The determination of the vehicle position in the traffic-node-fixed coordinate system by means of the proposed apparatus can be performed, for example, at a point in time at which the vehicle enters or drives into a spatial region, which can also be referred to as the traffic node region, having predetermined size around the traffic node. For example, the determination can be carried out when the traffic-node-side transmitter unit receives a request signal emitted at the vehicle with a received power which is greater than a predetermined threshold value.

The apparatus advantageously enables the entry direction or driving-in direction of a vehicle into the traffic node region to be determined, without a separate localization of the vehicle being necessary.

Overall, a precise determination, which can be carried out with simple computer technology and rapidly, of the vehicle position in the traffic-node-fixed coordinate system is advantageously possible, wherein generally already existing vehicle-side elements are used and wherein complex detection of the vehicle in the traffic node region by a traffic-node-side detection unit is not necessary.

In a further embodiment, the unit for determining an item of travel direction information is designed as an inertial sensor or comprises an inertial sensor. The inertial sensor can be designed in particular such that the inertial sensor can generate an output signal, which represents an angle between a travel direction vector of the vehicle and a spatial direction of the global reference coordinate system. In particular, the output signal can represent an angle between the travel direction vector and a direction which is oriented toward the magnetic north pole. This direction can be a reference direction in the global reference coordinate system. Such inertial sensors are regularly provided in vehicles. Existing elements in the vehicle can thus advantageously be used for the proposed apparatus, which reduces an installation space requirement and production costs. Furthermore, inertial sensors advantageously enable a reliable and accurate determination of the travel direction.

In one preferred embodiment, the inertial sensor is designed as a magnetometer. The magnetometer can be designed in particular as a magnetometer-compass. The magnetometer enables the detection of the earth's magnetic field, in particular also the direction of the earth's magnetic field. This in turn advantageously enables the determination of an angle between the vehicle longitudinal direction and the magnetic north direction (magnetic north).

In a further embodiment, a yaw angle is determinable as the item of travel direction information. The yaw angle refers to an angle between a vehicle longitudinal direction and a reference direction of the global reference coordinate system. In particular, the yaw angle can be detected by the above-explained inertial sensor. The yaw angle can in this case in particular be the angle between the vehicle longitudinal direction and a direction which is oriented toward the magnetic north pole. The yaw angle, which is generally determined in the scope of the operation of further vehicle assistance systems, can thus advantageously also be used for determining the vehicle position in the traffic-node-fixed coordinate system.

In a further embodiment, the apparatus comprises a transmitter unit for transmitting the vehicle position in the traffic-node-fixed coordinate system. The transmitter unit can be part of the above-explained transceiver unit. Therefore, items of information with respect to the vehicle position in the traffic-node-fixed coordinate system can be transmitted from the vehicle to a higher-order control unit, which can control a traffic flow through the traffic node on the basis of this vehicle position.

In a further embodiment, the apparatus comprises a unit for route determination of the vehicle, wherein an updated vehicle position is determinable as a function of the last determined vehicle position and a covered route. The route can be a route of the vehicle which it has covered between two points in time.

For example, the determination of the vehicle position in the traffic-node-fixed coordinate system can be carried out only once or initially as a function of the item of travel direction information and the position of the traffic-node-side transmitter unit in the vehicle coordinate system, in particular if the vehicle enters the above-explained spatial region around the traffic node for the first time at an entry point in time. However, it can be desirable to determine the vehicle position in the traffic-node-fixed coordinate system also at subsequent points in time, i.e., also chronologically after the entry. In principle, it would be possible to carry out the above-explained determination of the vehicle position in the traffic-node-fixed coordinate system again at these subsequent points in time. Preferably, however, at a further point in time which follows the entry point in time, a route can be determined, which was covered between the further point in time and the entry point in time by the vehicle. The route information can comprise an item of distance information and an item of direction information for this purpose. The vehicle position determined at the entry point in time can then be updated as a function of the route information. For example, it is possible to determine components of the route in spatial directions of the vehicle coordinate system and convert them into the traffic-node-fixed coordinate system. The converted components can then be added to the vehicle position determined at the entry point in time.

The updated vehicle position in the traffic-node-fixed coordinate system can then, of course, also be transmitted to a higher-order system.

In a further embodiment, the unit for route determination comprises the unit for determining the item of travel direction information, a unit for determining a vehicle acceleration and/or a unit for determining a vehicle velocity and/or at least one unit for determining the rotation or the rotational velocity of the vehicle. The units are preferably used for determining the mentioned variables in a three-dimensional space. A unit for determining a vehicle velocity can be designed, for example, as an acceleration sensor, in particular as a three-dimensional acceleration sensor. A unit for determining a vehicle rotation, in particular in three-dimensional space, can be designed as a sensor for a yaw angle, a pitch angle, and/or a roll angle or as a sensor for a yaw angular velocity, a pitch angular velocity, and/or a roll angular velocity. These units advantageously enable a simple determination of a travel direction and a covered path between two points in time.

An arrangement for determining a vehicle position in a traffic-node-fixed coordinate system is furthermore proposed. The arrangement comprises an apparatus for determining the vehicle position according to one of the embodiments described in this disclosure. Furthermore, the arrangement comprises a traffic-node-side transmitter unit. The arrangement can furthermore comprise a control unit associated with the traffic node. This control unit can control a traffic flow through the traffic node as a function of the determined vehicle positions. The traffic-node-side transmitter unit can be designed in this case according to one or more aspect(s) explained in this disclosure.

An arrangement advantageously results in this way, by means of which a precise determination, which can be carried out rapidly chronologically and computationally, of the vehicle position in the traffic-node-fixed coordinate system can be carried out.

Furthermore, a method is proposed for determining a vehicle position in a traffic-node-fixed coordinate system. The method can be carried out by means of an apparatus according to one of the embodiments described in this disclosure. The apparatus is therefore designed such that the proposed method can be carried out by means of the apparatus.

In this case, a signal of a traffic-node-side transmitter unit is received by a vehicle-side receiver unit. This signal can be in particular a response signal to a request signal emitted at the vehicle.

Furthermore, an item of travel direction information is determined in a global reference coordinate system, wherein a spatial relationship between the global reference coordinate system and the traffic-node-fixed coordinate system is previously known. This was explained above.

Furthermore, a position of the traffic-node-side transmitter unit in a vehicle coordinate system is determined as a function of at least one signal property of a received signal.

The vehicle position in the traffic-node-fixed coordinate system is then determined as a function of the item of travel direction information and the position of the traffic-node-side transmitter unit in the vehicle coordinate system. The method can be carried out in particular by means of a vehicle-side analysis unit.

The method can be carried out in particular when the vehicle is detected for the first time at an entry point in time in a predetermined spatial region around the traffic node. The method advantageously enables a precise determination, which can be carried out rapidly and easily computationally, of the vehicle position in the traffic-node-fixed coordinate system. Furthermore, in general already existing elements and/or sensors are advantageously used.

The method can be carried out once at the entry point in time for this purpose. As explained in greater detail hereafter, this entry or initial vehicle position determined in this manner can subsequently be updated.

In a further embodiment, a yaw angle is determined as the item of travel direction information, wherein the yaw angle refers to an angle between a vehicle longitudinal direction and a reference direction of the global reference coordinate system. This was explained above.

In a further embodiment, an updated vehicle position in the traffic-node-fixed coordinate system is determined as a function of the last determined vehicle position in the traffic-node-fixed coordinate system and a covered route. The route can be determined in this case by a unit for route determination.

Furthermore, a vehicle is described, wherein the vehicle comprises an apparatus for determining the vehicle position in the traffic-node-fixed coordinate system according to one of the embodiments described in this disclosure.

Furthermore, a method is described for controlling a traffic flow through a traffic node. For this purpose, the vehicle position in the traffic-node-fixed coordinate system is determined for at least one vehicle by a method according to one of the embodiments described in this disclosure. Furthermore, the traffic flow is controlled as a function of the vehicle position determined in this manner. The control can be performed in particular by determining and transmitting travel direction control signals and travel velocity control signals to the vehicle.

The invention will be explained in greater detail on the basis of an exemplary embodiment. In the figures:

FIG. 1 shows a schematic block diagram of an apparatus according to the invention,

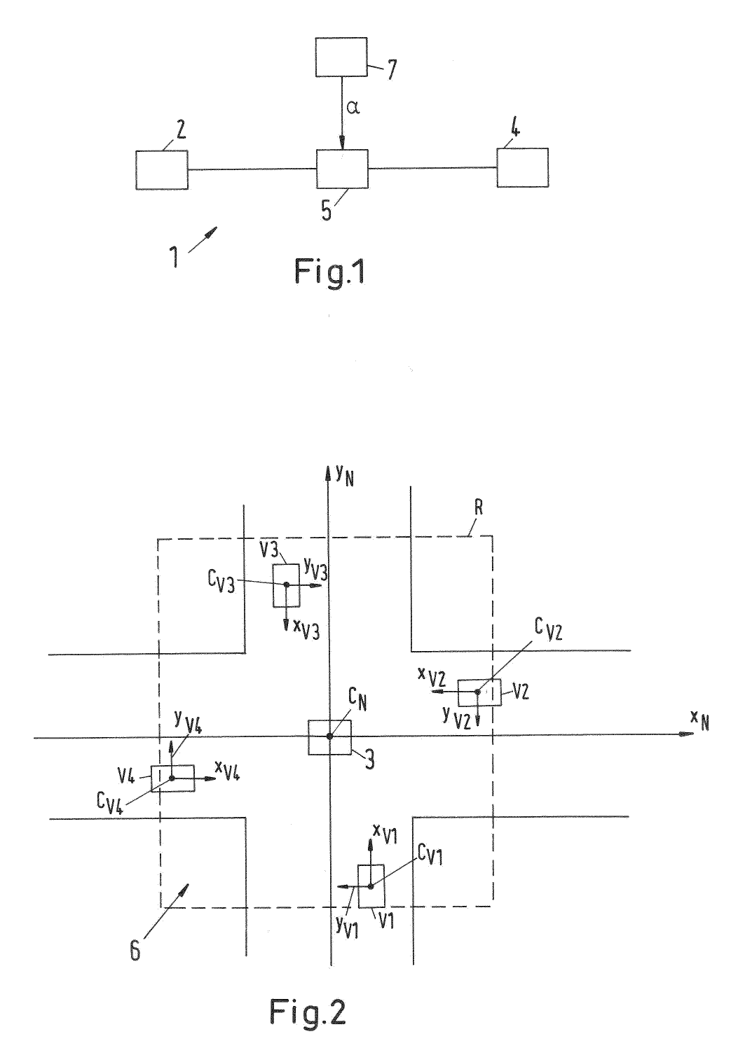

FIG. 2 shows a schematic top view of a traffic node having multiple vehicles, and

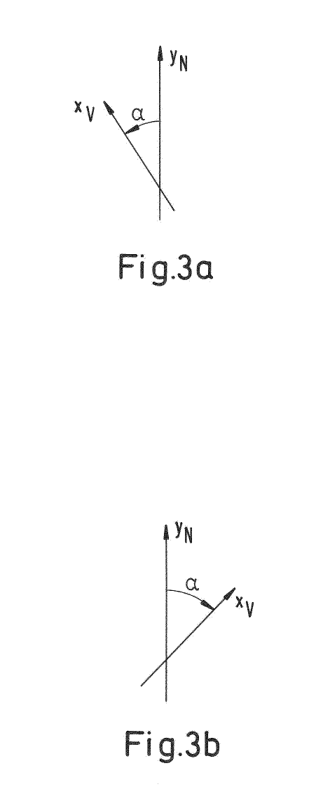

FIGS. 3a-3c show the exemplary determination of a travel direction.

Hereafter, identical reference signs identify elements having identical or similar technical features.

FIG. 1 shows a schematic block diagram of an apparatus 1 according to the invention for determining a vehicle position in a traffic-node-fixed coordinate system. The apparatus 1 is arranged in a vehicle V1, V2, V3, V4 (see FIG. 2). The apparatus 1 comprises a transceiver unit 2. By means of the vehicle-side transceiver unit 2, signals of a traffic-node-side transceiver unit 3 (see FIG. 2) can be received. Furthermore, the apparatus 1 comprises an inertial sensor designed as a magnetometer-compass sensor 7, wherein a yaw angle α can be determined by means of the magnetometer-compass sensor 7. Furthermore, the apparatus 1 comprises a velocity sensor 4, which detects a velocity of the vehicle V1, V2, V3, V4.

The vehicle-side transceiver unit 2, the magnetometer-compass sensor 7, and the velocity sensor 4 are connected to transmit signals and/or data to an analysis unit 5, which is also part of the apparatus 1. As explained in greater detail hereafter, a position of the traffic-node-side transmitter unit 3 in a vehicle coordinate system can be determined by means of the analysis unit 5 as a function of at least one signal property of a signal received by the transceiver unit 2. Furthermore, the vehicle position in the traffic-node-fixed coordinate system can be determined as a function of the yaw angle α and the position of the traffic-node-side transmitter unit 3 in the vehicle coordinate system by means of the analysis unit 5.

FIG. 2 shows a schematic top view of an intersection 6 having four road sections, wherein each road section respectively comprises one entrance and one exit. Furthermore, a first vehicle V1, which travels along the entrance of a first road section toward the center of the intersection 6 is shown. Accordingly, a second, a third, and a fourth vehicle V2, V3, V4 travel along the entrances of the further road sections toward the center of the intersection 6. A method for determining a vehicle position in a traffic-node-fixed coordinate system is described by way of example for the first vehicle V1. The same method can obviously be used for determining the vehicle position of the further vehicles V2, V3, V4. The first vehicle V1 and all further vehicles V2, V3, V4 can each comprise one apparatus 1 (see FIG. 1).

The first vehicle V1 can periodically emit request signals by means of the transceiver unit 2. These signals can be received by a traffic-node-side transceiver unit 3. If a received power of a request signal is greater than a predetermined threshold value, the traffic-node-side transceiver unit 3 thus generates a response signal, which is in turn received by the vehicle-side transceiver unit 2.

As a function of a run time of this response signal, which was emitted by the traffic-node-side transceiver unit 3, a distance of the vehicle-side transceiver unit 2 from the traffic-node-side transceiver unit 3 can be determined in a vehicle coordinate system of the first vehicle V1. The vehicle coordinate system of the first vehicle V1 comprises a vehicle longitudinal axis x_{V1}, which can be oriented parallel to a roll axis of the vehicle V1. Furthermore, the vehicle coordinate system of the first vehicle V1 comprises a transverse direction y_{V1}, which can be oriented parallel to a pitch axis of the vehicle V1. A vertical axis of the first vehicle V1, which can be oriented parallel to a yaw axis of the first vehicle V1, is not shown. Furthermore, an origin C_{V1} of the vehicle coordinate system of the first vehicle V1 is shown.

Correspondingly, the coordinate systems of the further vehicles V2, V3, V4 also comprise longitudinal directions x_{V2}, x_{V3}, x_{V4} and transverse directions y_{V2}, y_{V3}, y_{V4} and also origins C_{V2}, C_{V3}, C_{V4}.

A location of the vehicle-side transceiver unit 2 in the vehicle coordinate system of the first vehicle V1 is previously known.

A location of the traffic-node-side transceiver unit 3 in a traffic-node-fixed coordinate system is also previously known. This traffic-node-fixed coordinate system comprises a longitudinal direction x_{N} and a transverse direction y_{N}, wherein the transverse direction y_{N} is oriented in the direction toward the magnetic north pole.

Furthermore, an origin C_{N} of the traffic-node-fixed coordinate system is shown, which is arranged in the center point of the entrances.

Since the location of the transceiver units 2, 3 in the respective coordinate systems thereof is previously known, as a function of the run time of the signal, a distance between the origin C_{V1} of the vehicle coordinate system of the first vehicle V1 and the origin C_{N} of the traffic-node-fixed coordinate system can be determined. The angle of incidence of the response signal received by the vehicle-side receiver unit in the vehicle coordinate system can also be determined. The angle of incidence and the distance can be coded as a direction vector in the vehicle coordinate system, wherein the direction vector is oriented from the origin C_{V1} of the vehicle coordinate system of the first vehicle V1 toward the origin C_{N} of the traffic-node-fixed coordinate system and wherein the absolute value of the direction vector corresponds to the distance.

The position of the origin C_{N} of the traffic-node-fixed coordinate system in the vehicle coordinate system of the first vehicle V1 can therefore be determined as the vector (x(C_{N})_{V1};y(C_{N})_{V1}).

Furthermore, a yaw angle α of the first vehicle V1 is determined. The yaw angle a refers in this case to an angle between the vehicle longitudinal direction x_{V1} of the first vehicle V1 and the direction which is oriented toward the magnetic north pole. This direction can also be referred to as magnetic north. This direction forms a reference direction of a global reference coordinate system in this case. The direction toward the magnetic north pole is oriented parallel to the transverse direction y_{N}.

In the exemplary embodiment shown in FIG. 2, the yaw angle of the first vehicle V1 is 0°. The magnetometer-compass sensor can possibly detect a yaw angle α different from 0°, wherein this deviation can be caused by measurement noise, in particular a measurement noise according to a zero-mean Gaussian distribution.

A standard deviation of this measurement noise can be, for example, between 1° (inclusive) and 5° (inclusive).

Accordingly, a yaw angle α of the second vehicle V2 is 90°, a yaw angle α of the third vehicle V3 is 180°, and a yaw angle α of the fourth vehicle V4 is 270° or −90°.

As a function of the yaw angle α determined in this manner (see FIG. 3a), a transformation matrix T_{R} can then be determined. The transformation matrix T_{R} enables the conversion of the coordinates of the origin C_{N} of the traffic-node-fixed coordinate system in the vehicle coordinate system of the first vehicle V1 into coordinates of the origin C_{V1} of the coordinate system of the first vehicle V1 in the traffic-node-fixed coordinate system. This can be performed, for example, according to

(x(C_{V1})_{N};y(C_{V1})_{N})=T_{R}·(x(C_{N})_{V1};y(C_{N})_{V1}) Formula 1

The method can be carried out when a vehicle V1, V2, V3, V4 drives into a predetermined region R around the origin C_{N} of the traffic-node-fixed coordinate system for the first time at an entry point in time. In particular, the described method can be carried out once at the entry point in time. The vehicle position determined in this manner in the traffic-node-fixed coordinate system can then be transmitted via the transceiver unit 2 to a central control unit (not shown), wherein the central control unit can control a traffic flow through the intersection 6 as a function of the transmitted vehicle position.

Furthermore, the vehicle position in the traffic-node-fixed coordinate system can be determined again after this first point in time. For this purpose, for example, a route of the vehicle V1, V2, V3, V4 between the entry point in time and a later, further point in time can be determined, wherein the route can be determined as a function of items of velocity information and items of travel direction information. The items of velocity information can be determined as a function of the output signals of the velocity sensor 4 (see FIG. 1) and the items of travel direction information can be determined as a function of the yaw angle α (see FIG. 1). Furthermore, the vehicle position determined at the entry point in time in the traffic-node-fixed coordinate system can be determined as a function of the route covered between the entry point in time and the further point in time.

FIG. 3a shows an exemplary yaw angle α, which is determined between a vehicle longitudinal direction x_{V} and a transverse direction y_{N} of the traffic-node-fixed coordinate system, wherein the transverse direction y_{N} is oriented parallel to a direction toward the magnetic north pole. In FIG. 3a, the yaw angle is positive and is approximately 30°. In FIG. 3b, the yaw angle α is negative and is approximately −30°.

### LIST OF REFERENCE SIGNS

1 apparatus
2 vehicle-side transceiver unit
3 traffic-node-side transceiver unit
4 velocity sensor
5 analysis unit
6 intersection
7 magnetometer-compass sensor
x_{N} longitudinal direction of the traffic-node-fixed coordinate system
y_{N} transverse direction of the traffic-node-fixed coordinate system
C_{N} origin of the traffic-node-fixed coordinate system
x_{V1}, x_{V2}, x_{V3}, x_{V4} longitudinal directions of the vehicle coordinate systems
y_{V1}, y_{V2}, y_{V3}, y_{V4} transverse directions of the vehicle coordinate systems
C_{V1}, C_{V2}, C_{V3}, C_{V4} origins of the vehicle coordinate systems
α yaw angle

1-11. (canceled)

12. An apparatus for determining a vehicle position in a traffic-node-fixed coordinate system, the apparatus comprising:
a receiver unit for receiving a signal of a traffic-node-side transmitter unit;
a unit for determining an item of travel direction information in a global reference coordinate system;
wherein a spatial relationship between the global reference coordinate system and the traffic-node-fixed coordinate system is known; and
an analysis unit;
said analysis unit being configured to determine a position of the traffic-node-side transmitter unit in a vehicle coordinate system as a function of at least one signal property of a signal received by said receiver unit; and
said analysis unit being configured to determine a position of the vehicle position in the traffic-node-fixed coordinate system is determinable as a function of the item of travel direction information and the position of the traffic-node-side transmitter unit in the vehicle coordinate system.

13. The apparatus according to claim 12, wherein said unit for determining the item of travel direction information is an inertial sensor or includes an inertial sensor.

14. The apparatus according to claim 13, wherein said inertial sensor is a magnetometer.

15. The apparatus according to claim 12, wherein the item of travel direction information is a yaw angle, the yaw angle being an angle between a vehicle longitudinal direction and a reference direction of the global reference coordinate system.

16. The apparatus according to claim 12, which further comprises a transmitter unit for transmitting the vehicle position in the traffic-node-fixed coordinate system.

17. The apparatus according to claim 12, which comprises a route determining unit for route determination of the vehicle, wherein an updated vehicle position is determined as a function of a last determined vehicle position and a covered route.

18. The apparatus according to claim 17, wherein the route determining unit comprises said unit for determining the item of travel direction information, a unit for determining a vehicle acceleration, and/or a unit for determining a vehicle velocity.

19. An arrangement for determining a position of a vehicle in a traffic-node-fixed coordinate system, the arrangement comprising an apparatus according to claim 12 and a traffic-node-side transmitter unit.

20. A method for determining a vehicle position in a traffic-node-fixed coordinate system, the method comprising:
receiving a signal of a traffic-node-side transmitter unit by a vehicle-side receiver unit;
determining an item of travel direction information in a global reference coordinate system, wherein a spatial relationship between the global reference coordinate system and the traffic-node-fixed coordinate system is previously known;
determining a position of the traffic-node-side transmitter unit in a vehicle coordinate system as a function of at least one signal property of the received signal; and
determining the vehicle position in the traffic-node-fixed coordinate system as a function of the item of travel direction information and the position of the traffic-node-side transmitter unit in the vehicle coordinate system.

21. The method according to claim 20, wherein the item of travel direction information is a yaw angle being an angle between a vehicle longitudinal direction and a reference direction of the global reference coordinate system.

22. The method according to claim 20, which comprises determining an updated vehicle position as a function of a last determined vehicle position and a covered route.
